(19) United States
(12) Patent Application Publication
(10) Pub. No.: US 2022/0073771 A1
(43) Pub. Date: Mar. 10, 2022

(54) BLACK NON-AQUEOUS INKJET INK

(71) Applicant: Hewlett-Packard Development Company, L.P., Spring, TX (US)

(72) Inventor: Milton Neill Jackson, Corvallis, OR (US)

(73) Assignee: Hewlett-Packard Development Company, L.P., Spring, TX (US)

(21) Appl. No.: 17/417,410

(22) PCT Filed: Aug. 27, 2019
(86) PCT No.: PCT/US2019/048334

§ 371 Date: Jun. 23, 2021

Related U.S. Application Data
(63) Continuation of application No. PCT/US2019/023205, filed on Mar. 20, 2019.

(51) Int. Cl. C09D 11/326; C09D 11/103; C09D 11/36; C09D 11/037; C09D 11/38; C09D 11/106; C08K 5/10; C08K 5/05; C08L 29/14; C08G 65/00; C08K 5/37

(52) U.S. Cl. CPC C09D 11/326; C09D 11/103; C09D 11/36; C09D 11/037; C09D 11/38; C08K 5/37; C08K 5/10; C08K 5/05; C08L 29/14; C08G 65/007; C09D 11/106

(57) ABSTRACT

A black non-aqueous inkjet ink includes a colorant package including a black pigment; a polymeric dispersant; a phenol-formaldehyde resin; a C₂ to C₆ ester solvent; and a balance of a C₁ to C₅ alcohol solvent. The black pigment and the polymeric dispersant are present in a weight ratio ranging from about 1:0.4 to about 1:0.6. The phenol-formaldehyde resin is a C₃ to C₈ alkyl-modified phenol-formaldehyde resin.

### CROSS-REFERENCE TO RELATED APPLICATIONS

This application claims priority to International Patent Application Number PCT/US2019/023205 filed Mar. 20, 2019, the content of which is incorporated by reference herein in its entirety.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., plain paper, coated paper, etc.), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for making an example of a black non-aqueous inkjet ink disclosed herein;

FIG. 2 is a flow diagram illustrating an example of a printing method;

FIG. 3 is a graph depicting the viscosity (cp, Y-axis) versus pigment concentration (wt %, X-axis) for example inks and comparative example inks;

FIGS. 4A and 4B are graphs depicting the black optical density (KOD, Y-axis) versus print density (%, X-axis) for example inks printed on untreated low density polyethylene (FIG. 4A) and on polyethylene terephthalate (FIG. 4B);

FIGS. 5A and 5B are black and white reproductions of photographs of comparative example ink printed on untreated low density polyethylene (FIG. 5A) and an example ink printed on untreated low density polyethylene (FIG. 5B); and

FIGS. 6A and 6B are black and white reproductions of photographs of one example ink (without the addition of cyan dye) printed on low density polyethylene (FIG. 6A) and another example ink (with the addition of cyan dye) printed on low density polyethylene (FIG. 6B).

### DETAILED DESCRIPTION

Inkjet printing on non-porous polymeric substrates can present challenges due to the low surface energy of the substrate, and because these types of substrates tend to resist fluid penetration. The resistance to fluid penetration may be more prevalent when the non-porous polymeric substrate is untreated, i.e., has not been exposed to a surface treatment that renders the substrate more susceptible to ink adhesion. The term “untreated” indicates that a printing surface of a non-porous polymeric substrate has not been mechanically or chemically modified, such as by mechanical or chemical abrasion or by the application of a chemical ink receiving coating, for example. In some examples, the non-porous polymeric substrates can be materials, such as polyolefins, which lack functional groups that may otherwise aid in the adhesion of ink to the substrate.

Black solvent-based inkjet inks have been shown to exhibit inconsistent print quality (e.g., optical density <0.5, shift in color hue, etc.), durability, and dry times across different non-porous polymeric substrates. This may be due to variations in the substrate, ink coalescence, ink viscosity, ink dispersing agents, ink resin(s), and/or the ink vehicle.

Examples of the black non-aqueous inkjet ink disclosed herein are formulated with pigment dispersions that include a black pigment to polymeric dispersant weight ratio ranging from about 1:0.4 to about 1:0.6. It has unexpectedly been found that the black pigment is effectively dispersed even at these relatively low dispersant levels and in the attenuated electrolytic environment (compared to a water-based vehicle) of the solvent-based vehicle (which, in other inks, has been compensated for with excess amounts of dispersant relative to pigment). A lower dispersant level in the pigment dispersion enables more of the pigment dispersion to be added to the black non-aqueous inkjet ink, which contributes to improved print quality (e.g., optical density <0.7). Moreover, the lower dispersant level does not undesirably increase the viscosity (e.g., >2.25 cp). As such, the viscosity of the black non-aqueous inkjet ink disclosed herein is maintained at a desirable level for achieving jetting reliability (e.g., good nozzle health).

Some examples of the black non-aqueous inkjet ink disclosed herein also include a cyan colorant, which has been found to shift the color hue of the ink to a more neutral black.

Still further, examples of the black non-aqueous inkjet ink disclosed herein include specific amounts of each of an ester solvent and an alcohol solvent. It has been found that the solvent combination, when present in the ink in the specific amounts, significantly reduces dry times (e.g., to <3 seconds) on treated and untreated non-porous polymeric substrates. Reduced dry times enable quicker film formation on the surface of the non-porous polymeric substrate, which is particularly desirable in large scale commercial printing. Fast dry times can also lead to higher quality prints that have a desirable durability.

Examples of the ink formulation also include a phenol-formaldehyde resin. Some examples of the ink formulation disclosed herein also include a specific combination of a phenol-formaldehyde resin and a polyvinyl butyral resin. It has been found that the resin combination, when present in the ink in the specific ratios (with respect to each other) and amounts (with respect to the total ink formulation) disclosed herein, significantly increases ink adhesion to both treated and untreated non-porous polymeric substrates.

In addition to the non-aqueous inkjet inks, the examples disclosed herein relate to printing kits, methods of making, and printing methods. It is noted that when discussing the non-aqueous inkjet ink(s), the printing kit(s), the method(s) of making, and the printing method(s), these various discussions can be considered applicable to other examples whether or not they are explicitly discussed in the context of that example. Thus, for example, in discussing a solvent related to an example of the non-aqueous inkjet ink, such disclosure is also relevant to and directly supported in context of the printing kit(s), the method(s) of making, the printing method(s), vice versa, etc.

Throughout this disclosure, a weight percentage that is referred to as “wt % active(s)” refers to the loading of an active component of a dispersion or other formulation that is present in the non-aqueous inkjet ink. For example, a pigment may be present in a solvent-based formulation (e.g., a pigment dispersion or stock solution) before being incorporated into the inkjet ink. In this example, the wt % actives of the pigment accounts for the loading (as a weight percent) of the pigment that is present in the inkjet ink, and does not account for the weight of the other components (e.g., dispersant, solvent, etc.) that are present in the formulation with the pigment. The term “wt %,” without the term active(s), refers to either i) the loading (in the non-aqueous inkjet ink) of a 100% active component that does not include other non-active components therein, or ii) the loading (in the non-aqueous inkjet ink) of a material or component that is used “as is” and thus the wt % accounts for both active and non-active components.

Non-Aqueous Inkjet Inks

In an example, the non-aqueous inkjet ink comprises or consists of a colorant package including a black pigment; a polymeric dispersant, wherein the black pigment and the polymeric dispersant are present in a weight ratio ranging from about 1:0.4 to about 1:0.6; a phenol-formaldehyde resin, wherein the phenol-formaldehyde resin is a C₃ to C₈ alkyl-modified phenol-formaldehyde resin; a C₂ to C₆ ester solvent; and a balance of a C₁ to C₅ alcohol solvent. These examples of the non-aqueous inkjet ink exhibit consistent printing performance, especially in terms of optical density, on different types of treated or untreated non-porous polymeric substrates. In some examples, the colorant package consists of the black pigment and a cyan colorant. In any of these examples, when the non-aqueous inkjet ink comprises these components, the inkjet ink may also include phenol-formaldehyde resin and/or other suitable inkjet additives, such as a non-ionic surfactant. When the non-aqueous inkjet ink consists of any of these components, the ink may include a small amount of water that is introduced with the black pigment, but does not include any other additives.

In another example, the non-aqueous inkjet ink, consists of a colorant package consisting of a non-self-dispersed black pigment and a cyan colorant; a polymeric dispersant, wherein the non-self-dispersed black pigment and the polymeric dispersant are present in a weight ratio ranging from about 1:0.4 to about 1:0.6; from about 0.25 wt % to about 0.35 wt % of a perfluoropolyether surfactant, a hydroxythioether surfactant, or a combination thereof, based on a total weight of the black non-aqueous inkjet ink; from about 2 wt % to about 10 wt % of a C₂ to C ester solvent, based on the total weight of the black non-aqueous inkjet ink; water in an amount less than 1 wt %, based on the total weight of the black non-aqueous inkjet ink; a balance of a C₁ to C₅ alcohol solvent; and an optional resin package consisting of a C₃ to C₈ alkyl-modified phenol-formaldehyde resin and a polyvinyl butyral resin.

Colorant Package

In some examples, the colorant package in the non-aqueous inkjet inks includes a black pigment. In some of these examples, the colorant package may consist of the black pigment, without any other colorant. In other examples, the colorant package in the non-aqueous inkjet inks consists of a black pigment and a cyan colorant.

The black pigment may be a non-self-dispersed pigment, i.e., the pigment is not self-dispersing. As such, the black pigment may be incorporated into the non-aqueous inkjet ink as part of a black pigment dispersion. The black pigment dispersion may include the black non-self-dispersed pigment; a polymeric dispersant; and one or more co-solvents that are compatible with the solvent package of the non-aqueous inkjet ink.

Carbon black is a suitable non-self-dispersed inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

The average particle size of the black pigment may range anywhere from about 20 nm to less than 175 nm. In an example, the average particle size ranges from about 70 nm to about 150 nm. Smaller pigment particles may be desirable to improve ink stability. The pigment particle size may be determined using a NANOTRAC® Wave device, from Microtrac, e.g., NANOTRAC® Wave II or NANOTRAC® 150, etc., which measures particles size using dynamic light scattering (DLS). Average particle size can be determined using particle size distribution data generated by the NANOTRAC® Wave or another suitable DLS device. The particle size distribution data may be a volume distribution.

Any of the black pigments mentioned herein can be dispersed by a separate dispersant, such as polyvinyl butyral (PVB) or variants thereof (e.g., poly(vinyl butyral-co-vinyl alcohol-co-vinyl acetate). Some commercially available examples of PVB include BUTACITE® (PVB thermoplastic sheet material from Kuraray), MOWITAL® (from Kuraray), BUTVAR® (thermoplastic PVB resin from Eastman). In the pigment dispersion (and in the inkjet ink formed with the pigment dispersion), the non-self-dispersed black pigment and the polymeric dispersant are present in a weight ratio ranging from about 1:0.4 to about 1:0.6.

The balance of the pigment dispersion may be any alcohol solvent that is compatible with the ink solvent package. In an example, a black pigment dispersion including a C₁ to C₅ alcohol solvent has been found to be particularly stable when included in the solvent package disclosed herein. Any of the C₁ to C₅ alcohol solvents disclosed herein may be used in the pigment dispersion.

In the black pigment dispersion, the pigment may be present in an amount of about 10 wt % (based on a total weight of the pigment dispersion), the dispersant may be present in an amount ranging from about 4 wt % to about to about 6 wt % (based on a total weight of the pigment dispersion), and the balance may be the C₁ to C₅ solvent.

Enough of the black pigment dispersion is added to the solvent package so that the black pigment is present in the black non-aqueous inkjet ink in an amount up to 4 wt %, based on a total weight of the black non-aqueous inkjet ink; and the polymeric dispersant is present in the black non-aqueous inkjet ink in an amount up to about 2.4 wt %, based on the total weight of the black non-aqueous inkjet ink. In other words, the non-aqueous inkjet ink includes up to 4 wt % of the pigment solids and up to 2.4 wt % of the dispersant solids.

It is to be understood that the liquid components of the black pigment dispersion become part of the liquid vehicle in the inkjet ink.

In addition to the black pigment dispersion, the colorant package may also include the cyan colorant. The cyan colorant is a cyan dye or a cyan pigment.

Any cyan dye may be used. Examples of cyan dyes include Savinyl Blue RS, Alcian Blue 8GX (C.I. Ingrain Blue), Brilliant cresyl blue (C.I. Basic dye), Meldola blue (C.I. Basic Blue 6), Victoria blue 4R (C.I. Basic Blue 8), Victoria blue B (C.I. Basic Blue 26), Victoria blue R (C.I. Basic Blue 11), and Xylene cyanol FF (C.I. Acid Blue 147).

Any non-self-dispersed cyan pigment may be used. Examples of non-self-dispersed blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60. The cyan pigment may be dispersed with any suitable polymeric dispersant, which may vary depending upon the manufacturer of the pigment.

In an example, the cyan colorant is present, in the inkjet ink, in an amount ranging from about 0.5 wt % to about 2 wt %, based on a total weight of the black non-aqueous inkjet ink.

Solvent Package

The solvent package in the non-aqueous inkjet inks disclosed herein includes an alcohol solvent and an ester solvent. More specifically, the solvent package includes a C₁ to C₅ alcohol solvent and a C₂ to C₆ ester solvent. In some instances, the surfactants may also be considered as part of the solvent package. Suitable surfactants are discussed in more detail herein.

The alcohol solvent serves as the main or primary solvent vehicle component, making up 70 wt % or more of the total weight of the black non-aqueous inkjet ink. Thus, the “non-aqueous inkjet inks” of the present disclosure can be likewise referred to as “alcohol-based inkjet inks.” It should be noted that the term “non-aqueous” indicates that the ink compositions do not include water for purposes of providing a solvent vehicle for the non-aqueous inkjet ink as a whole. If some small amount of water is included in the non-aqueous inkjet inks of the present disclosure, such as may be the case when brought in with another component, e.g., a pigment dispersion, added surfactant or other additive(s) or component(s), then such inkjet inks are still considered to be “non-aqueous.” For further clarity, if less than about 1 wt %, or more typically, less than about 0.75% or even less than about 0.5 wt %, of water is present, the ink composition is still considered to be a “non-aqueous inkjet ink.”

The alcohol solvent can include a C₁ to C₅ alcohol. These alcohols can be selected from the group consisting of methanol, ethanol, n-propanol, isopropanol, cyclopropanol, butanol, n-butanol, 2-butanol, isobutanol, tert-butanol, cyclobutanol, pentanol, cyclopentanol, and a combination thereof. The C₁ to C₅ alcohol solvents used herein, for example, can be less aggressive than other types of solvents and may not degrade materials often found in inkjet architecture. The C₁ to C₅ alcohols can also improve dry time and provide enhanced solubility of various components. In some examples, the alcohol solvent can be denatured. In one example, the C₁ to C₅ alcohol solvent is ethanol denatured with tert-butanol and denatonium benzoate. In other examples, the alcohol solvent can be a straight chain alcohol. In still other examples, the alcohol solvent can be branched, e.g., isopropanol or one of the branched butanols. In one example, the alcohol solvent can include ethanol. In yet another example, the alcohol solvent can include n-propanol.

The alcohol solvent can be present in the ink formulation in an amount ranging from about 70 wt % to about 97 wt %, or from about 75 wt % to about 85 wt %, or from about 80 wt % to about 90 wt %, or from about 70 wt % to about 80 wt %, or from about 90 wt % to about 97 wt % each of which is based on a total weight of the black non-aqueous inkjet ink.

The ester solvent is a C₂ to C₆ ester solvent. In an example, the ester solvent is methyl acetate, ethyl acetate or another ester solvent that readily dissolves and/or emulsifies the surfactant(s). By improving surfactant dissolution and/or emulsification, the C₂ to C₆ ester solvent improves the decap performance of the ink.

In addition to helping to dissolve and/or emulsify the surfactant(s), it has been found that the ester solvent, when used in combination with the alcohol solvent in the respective amounts set forth herein, contributes to relatively consistent print performance across a wide variety of non-porous polymeric media. In other words, the inks disclosed herein, which include from about 2 wt % to about 10 wt % of the ester solvent and from about 70 wt % to about 97 wt % of the alcohol solvent, exhibit little performance variability across treated and untreated non-porous polymeric media. When the ester solvent is present in the ink in an amount less than 2 wt %, the readability of printed barcodes may degrade and/or the edge roughness of printed lines may increase. Alternatively, when the ester solvent is present in the ink in an amount greater than 10 wt %, the durability of the print may degrade. As such, the C₂ to C₆ ester solvent is present in an amount ranging from about 2 wt % to about 10 wt %, based on a total weight of the black non-aqueous inkjet ink. In some examples, the C₂ to C₆ ester solvent can be present in the ink formulation in an amount ranging from greater than 2 wt % to less than 8 wt %. In other examples, the C₂ to C₆ ester solvent can be present in the ink formulation in an amount ranging from greater than 2 wt % to less than or equal to 6 wt %. In still other examples, the C₂ to C₆ ester solvent can be present in the ink formulation in an amount ranging from about 2.5 wt % to about 5 wt %.

The combination of the C₂ to C₆ ester solvent and the C₁ to C₅ alcohol also contributes to the ink having exceptional dry time (<3 seconds) on non-porous polymeric media.

It is to be understood that any of the ester and alcohol solvents disclosed herein may be used in combination in the black non-aqueous inkjet ink. In one example, the C₂ to C₆ ester solvent is ethyl acetate, and the C₁ to C₅ alcohol solvent is ethanol denatured with tert-butanol and denatonium benzoate.

Surfactant

In some examples, the black non-aqueous inkjet ink further includes a perfluoropolyether surfactant, a hydroxythioether surfactant, or a combination thereof. The surfactant(s) may be considered to be part of the solvent package.

Perfluoropolyethers can have a positive impact on decap performance and can also reduce ink puddling when dispensing the solvent-based inks that are described herein. In one specific example, the perfluoropolyether can be a dialkyl amide perfluoropolyether, e.g., a perfluoropolyether backbone with ends functionalized with an alkyl amide group. A commercially available example of a dialkyl amide perfluoropolyether is FLUOROLINK® A10 or A10P (the pelletized version of A10), which is polyperfluoroethoxymethoxy difluoromethyl distearamide available from Solvay (Belgium). As mentioned herein, perfluoropolyethers can benefit from the presence of the C₂ to C₆ ester solvent, which dissolves and/or emulsifies the perfluoropolyether without further processing. The perfluoropolyether can be admixed/dissolved in the C₂ to C₆ ester solvent prior to admixing with the alcohol solvent, or it can be admixed after the alcohol solvent is present.

One example one example of the perfluoropolyether is a dialkyl amide perfluoropolyether, which may have a number-average molecular weight within the range from about 400 Daltons to about 4,000 Daltons. One example structural formula can be represented as Formula I, as follows:

—CF₂—(O—CF₂—CF₂)ₙ—(O—CF₂)ₘ—O—CF₂—X Formula I

where X can be —CONH—(C₉ to C₃₂ alkyl), e.g., C₁₈H₃₇, n can be from 1 to 53, and m can be from 31 to 1, for example. The C₉ to C₃₂ alkyl group can be different for the X on individual ends of the polymer. Furthermore, the C₉ to C₃₂ alkyl can be straight-chained or branched. In some examples, shorter or longer dialkyl amide perfluoropolyether chains can be used, but in more specific examples, m and n can be such that the number-average molecular weight can be from about 1,200 Daltons (or g/mol) to about 2,300 Daltons, or from about 1,200 Daltons to about 2,000 Daltons, or from about 2,000 Daltons to about 2,500 Daltons, or from about 2,100 Daltons to about 2,300 Daltons, etc.

The hydroxythioether surfactant may also be referred to as a hydroxyl thioether. The hydroxythioether structure is R′—S—ROH, where R and R′ are independently selected from an alkyl chain and an aromatic group. While the OH group is shown attached to the R group, it is to be understood that the OH group may be attached to either the R or R′ group or both of the R and R′ group. A commercially available example of a hydroxythioether surfactant is DYNOL™ 360, available from Evonik Ind.

The perfluoropolyether surfactant or the hydroxythioether surfactant may be used alone or in combination in the black non-aqueous inkjet ink. Whether used alone or in combination, the total amount of the perfluoropolyether surfactant and/or the hydroxythioether surfactant ranges from about 0.25 wt % to about 0.35 wt %. When the surfactant(s) is/are included in an amount greater than 0.35 wt %, the dry time becomes longer, and when the surfactant(s) is/are included in an amount less than 0.25 wt %, the decap performance degrades.

Resin Package

The resin package in some examples of the black non-aqueous inkjet ink include a phenol-formaldehyde resin. The resin package in some other examples of the black non-aqueous inkjet ink includes both a phenol-formaldehyde resin and a polyvinyl butyral resin.

The term “phenol-formaldehyde resin” refers generally to a genus or series of resins that includes alternating moieties of various phenols (modified or unmodified) and methylene (—CH₂— provided by the formaldehyde) groups, e.g., phenol-methylene-phenol-methylene, etc. One specific type of phenol-formaldehyde resin is a novolac resin that starts and ends the polymer chain with a phenol moiety (thus consuming the formaldehyde during polymerization and often leaving excess unreacted phenols in the reaction mixture). Phenol-formaldehyde resins can be linked together at the ortho position or the para position relative to the hydroxyl group positioned on the aromatic ring. In the examples disclosed herein, the phenol group of the phenol-formaldehyde resin is modified, e.g., with a C₃ to C₆ alkyl group, at the ortho or para position.

As mentioned, the phenol-formaldehyde resin can be a novolac resin. Novolac resins can be prepared without excess of formaldehyde so that formaldehyde is consumed during the polymerization process. Because the phenol groups react with the formaldehyde groups (typically) at the para- or ortho-position, and do not react with other phenol groups, the polymer formed includes alternating phenol-containing units (from the phenol group) and —CH₂— units (from the formaldehyde). As all of the formaldehyde groups are consumed, the end units of the polymer can both be provided by the phenol-containing group, e.g., phenol-CH₂-phenol-CH₂-phenol-CH₂-phenol, etc. In other words, the polymer begins and ends with phenol moieties. Thus, in one example, the phenol-formaldehyde resin can have a formaldehyde to phenol molar ratio of less than one. As the formaldehyde is used up during the formation of the phenol-formaldehyde resin, there is no excess formaldehyde present in the inkjet ink. The lack of excess formaldehyde can prevent the novolac resin from curing in the inkjet ink.

The molecular weight of the phenol-formaldehyde resin(s) disclosed herein can vary depending upon the chain length. With the alkyl-modified phenol-formaldehyde resin(s) disclosed herein, the molecular weight can also be increased per unit or “mer” along the polymer chain, due to other side groups (e.g., alkyls) that are positioned on the aromatic ring of the phenol in addition to the hydroxyl group. In some examples, the phenol-formaldehyde resin can have a weight average molecular weight ranging from about 1,000 to about 10,000, from about 1,000 to about 5,000, from about 1,000 to about 2,600, or from about 1,800 to about 2,600. The units of molecular weight throughout this disclosure are g/mol or Daltons.

In specific examples, the phenol-formaldehyde resin can have a softening point temperature within the range of from about 135° C. to about 180° C., or from about 135° C. to about 160° C., or from about 140° C. to about 170° C. “Softening point” or “softening temperature” of polymers described herein can be determined using the American Society for Testing and Materials (ASTM) protocol E28-14, sometimes referred to as the “ring and ball test.” Ring and ball testing occurs by bringing the material above the softening point and stirring until melted, e.g., 75° C. to 100° C. above the expected softening point. Two brass rings are heated to molten temperature and placed on a metal plate coated with dextrin and glycerin. The material is then placed on the rings, cooled for 30 minutes, and excess material is removed above the brass rings. The rings (with the material thereon) are bathed in water that extends 2 inches above the brass rings (starting at 5° C.). As the bath is warmed and stirred at a uniform rate, the material softens on the rings and two respective steel balls are placed on the polymer through the polymer material within the opening of the rings. The softening point is established by averaging the two temperatures recorded when the individual balls contact the metal plate. While example softening points are provided, it is to be understood that phenol-formaldehyde resins exhibiting a softening point outside of the given ranges can also be used.

In the examples disclosed herein, the phenol-formaldehyde resin is an alkyl-modified phenol-formaldehyde resin, where the alkyl ranges from a 3 carbon alkyl (C₃, propyl) to an 8 carbon alkyl (C₈, octyl). The C₃ to C₈ alkyl group can be straight chained or branched. It is noted that the phenol moiety can be modified with groups other than C₃ to C₈ alkyl groups, such as, for example, alicyclic groups, oxygen-modified side groups, nitrogen-modified side groups, sulfur-modified side groups, etc. Examples of an alkyl-modified phenol-formaldehyde resin suitable for the phenol-formaldehyde resin include butylphenol formaldehyde polymers, having a weight average molecular weight ranging from about 1,800 to 2,600 and a softening point from about 140° C. to about 150° C. The butylphenol formaldehyde can be, for example, a tert-butylphenol formaldehyde polymer (a.k.a., t-butylphenol-formaldehyde resin), such as para-tert-butylphenol formaldehyde in one example. That being stated, the C₃ to C₈ alkylphenol formaldehyde may include an alkylphenol that is ortho (o-) or para (p-) relative to the hydroxyl group. If para, the formaldehyde polymerization can occur at the ortho position. For example, the C₃ to C₈ alkyl group can be at the para-position and can be branched, e.g., para-tert-butylphenol-formaldehyde, and the polymerization can occur at the ortho position (both ortho positions occupied for polymerization except for at the end units where only one position may be occupied). If ortho, the formaldehyde polymerization can occur at either the other ortho position or at the para position. In one example, the phenol-formaldehyde resin is a t-butylphenol-formaldehyde resin. An example of a commercially available 4-t-butylphenol-formaldehyde resin that can be used as the phenol-formaldehyde resin in the inkjet inks disclosed herein is REACTOL™ 1111E (from Lawter, Inc.), which is non-reactive and highly soluble in C₁-C₄ acetates, e.g., >10% solubility in ethyl acetate.

The phenol-formaldehyde resin may lead to improved ink adhesion on non-porous polymeric substrates. For example, the aromatic phenol moieties may be able to interact with the C—H bonds of, e.g., polypropylene substrates, which can contribute to the improved adhesion of the ink to these substrates. Moreover, the phenol-formaldehyde resin does not result in kogation (build-up of ink solids on a thermal inkjet printhead) and thus the inks disclosed herein do not include an additional anti-kogation agent.

The polyvinyl butyral (PVB) resin is:

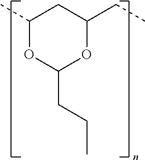

where n ranges from 70 to 120 so that the weight average molecular weight of the PVB is less than 20,000. It is to be understood that any PVB that is added as part of the resin package is in addition to any PVB dispersant that may be included in the ink as part of the pigment dispersion. As such, the weight ratio of the pigment to the polymeric dispersant does not include any PVB that may be added to the ink as part of the resin package.

When the resin package is included in the black non-aqueous inkjet ink, a ratio of the polyvinyl butyral resin to the phenol-formaldehyde resin ranges from 1:10 to 1:1.5; and a combined total of the polyvinyl butyral resin and the phenol-formaldehyde resin in the non-aqueous inkjet ink ranges from about 2 wt % active to about 3 wt % active, based on a total weight of the non-aqueous inkjet ink. In one example, the ratio of polyvinyl butyral resin to the phenol-formaldehyde resin is 1:4. In one example, the polyvinyl butyral resin is present in an amount of about 0.1 wt % active up to 1.0 wt % active (based on the total weight of the ink, and not including any PVB that may be present from the pigment dispersion), and the phenol-formaldehyde resin is present in an amount ranging from about 0.5 wt % active up to 2.5 wt % active (based on the total weight of the ink). In this example, the combined total of the polyvinyl butyral resin and the phenol-formaldehyde resin in the non-aqueous inkjet ink ranges from about 2 wt % active to about 3 wt % active.

Other Additives

Examples of the black non-aqueous inkjet ink compositions disclosed herein achieve desirable surface wetting, dry times, durability, and print quality. As such, in some examples of the inkjet ink, additional additive(s) are not included. It is to be understood, however, that a non-ionic surfactant may be desirable in some instances, as these surfactants can contribute to improved print performance (e.g., decap, etc.).

Examples of suitable non-ionic surfactants include a secondary alcohol ethoxylate, such as TERGITOL™ 15-S-7, or a nonylphenol ethoxylate, such as TERGITOL™ NP9 (from Dow Chemical); non-ionic acetylenic surfactants, such as SURFYNOL® 465, 420, 485 (from Evonik Ind.); polyoxyethylene sorbitan monostearate, such as TWEEN^{T}M 60 (from Croda Inc.); organosilicones, such as SILWET® L7622 (from Ribelin); and/or combinations thereof.

In an example, the black non-aqueous inkjet inks can include from about 0.1 wt % active to about 2 wt % active of the non-ionic surfactant, based on a total weight of the non-aqueous inkjet ink. In other examples, the non-ionic surfactant may be present in amounts ranging from about 0.1 wt % active to about 1.5 wt % active, or from about 0.25 wt % active to about 1 wt % active, each of which is based on a total weight of the non-aqueous inkjet ink.

The black non-aqueous inkjet ink may or may not include other inkjet additives. As one example, an antimicrobial may not be included, in part because the alcohol solvent helps to inhibit microbial growth.

Ink Properties

The viscosity (measured at ambient temperature (25° C.) and pressure (1 atm)) of the black non-aqueous inkjet ink may be less than 2.25 cp. In an example of the black non-aqueous inkjet ink including from about 3.7 wt % to about 4 wt % of the black pigment and from about 2.2 wt % to about 2.4 wt % of the polymeric dispersant, the viscosity (measured at ambient temperature and pressure) ranges from about 2 cp to about 2.25 cp. In another example of the black non-aqueous inkjet ink including from about 2.75 wt % to less than 3.7 wt % of the black pigment and from about 1.65 wt % to less than 2.2 wt % of the polymeric dispersant, the viscosity (measured at ambient temperature and pressure) ranges from about 1.5 cp to less than 2 cp. In still example of the black non-aqueous inkjet ink including from about 2 wt % to less than 2.75 wt % of the black pigment and from about 1.2 wt % to less than 1.65 wt % of the polymeric dispersant, the viscosity (measured at ambient temperature and pressure) ranges from about 1 cp to about 1.8 cp. Each of these inks exhibits reliable jettability as well as desirable optical density.

Method of Making

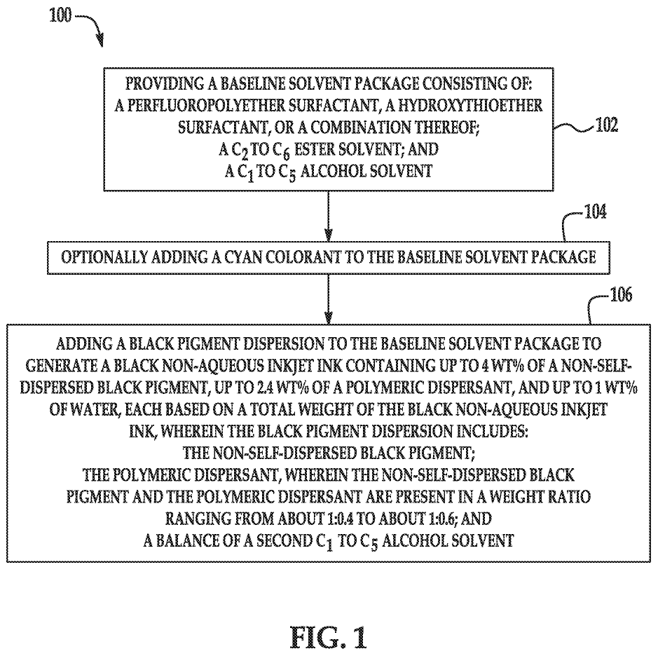

A method of making an example of the black non-aqueous inkjet ink is shown in FIG. 1. As depicted, the method 100 includes providing a baseline solvent package consisting of a perfluoropolyether surfactant, a hydroxythioether surfactant, or a combination thereof; a C₂ to C₆ ester solvent; and a C₁ to C₅ alcohol solvent (as shown at reference numeral 102); optionally adding a cyan colorant to the baseline solvent package (as shown at reference numeral 104); and adding a black pigment dispersion to the baseline solvent package to generate a black non-aqueous inkjet ink containing up to 4 wt % of a black non-self-dispersed pigment, up to 2.4 wt % of a polymeric dispersant, and up to 1 wt % of water, each based on a total weight of the black non-aqueous inkjet ink, wherein the black pigment dispersion includes the non-self-dispersed black pigment; the polymeric dispersant, wherein the non-self-dispersed black pigment and the polymeric dispersant are present in a weight ratio ranging from about 1:0.4 to about 1:0.6; and a balance of a second C₁ to C₅ alcohol solvent (as shown at reference numeral 106).

If included, the cyan colorant may be added to the baseline solvent package before, after, or simultaneously with the black pigment dispersion. Moreover, it is to be understood the cyan colorant and the black pigment dispersion may be mixed together before being added to (or having added thereto) the baseline solvent package.

The baseline solvent package includes any example of the perfluoropolyether surfactant and/or the hydroxythioether surfactant, and any example of the C₂ to C₆ ester solvent; and any example of the C₁ to C₅ alcohol solvent disclosed herein. The black pigment dispersion includes any examples of the black non-self-dispersed pigment, any example of the polymeric dispersant, and any example of the second C₁ to C₅ alcohol solvent disclosed herein. The cyan colorant includes any examples of the cyan pigment and/or cyan dye disclosed herein.

The amount of each component in the baseline solvent package may be adjusted so that after the (optional) cyan colorant and the black pigment dispersion are added, the final weight percentages of the surfactant(s), the C₂ to C₆ ester solvent; and the C₁ to C₅ alcohol solvent are within the ranges provided herein for examples of the black non-aqueous inkjet inks. For example, the final black ink may include from about 0.25 wt % to about 0.35 wt % of the perfluoropolyether surfactant, the hydroxythioether surfactant, or the combination thereof, based on the total weight of the black non-aqueous inkjet ink; and from about 2 wt % to about 10 wt % of a C₂ to C₆ ester solvent, based on the total weight of the black non-aqueous inkjet ink.

The amount of the cyan colorant that is added to the baseline solvent package is sufficient to introduce from about 0.5 wt % to about 2 wt %, based on the total weight of the black non-aqueous inkjet ink.

The amount of the black pigment dispersion that is added to the baseline solvent package is sufficient to render up to 4 wt % of the solid pigment and up to 2.4 wt % of the solid polymeric dispersant. The amount of the second C₁ to C₅ alcohol solvent that is present in the final ink will depend upon how much of the solvent is present in the black pigment dispersion and how much of the black pigment dispersion is added to the baseline solvent package.

Some examples of the method 100 also include adding a resin package to the baseline solvent package, the resin package consisting of a C₃ to C₈ alkyl-modified phenol-formaldehyde resin and a polyvinyl butyral resin. The amount of each resin is within the ranges provided herein.

Printing Kits

Any example of the black non-aqueous inkjet inks disclosed herein may be included in a printing kit with a suitable substrate (print medium, recording medium, etc.). In an example, the printing kit comprises: a treated or untreated non-porous polymeric substrate; and a black non-aqueous inkjet ink comprising or consisting of a colorant package consisting of a black pigment and a cyan colorant; a polymeric dispersant, wherein the black pigment and the polymeric dispersant are present in a weight ratio ranging from about 1:0.4 to about 1:0.6; a phenol-formaldehyde resin, wherein the phenol-formaldehyde resin is a C₃ to C₈ alkyl-modified phenol-formaldehyde resin; a polyvinyl butyral resin; a C₂ to C₆ ester solvent; and a balance of a C₁ to C₅ alcohol solvent.

With regard to the non-porous polymeric substrate, the term “non-porous” does not infer that the substrate is devoid of any and all pores in every case, but rather indicates that the substrate does not permit bulk transport of a fluid through the substrate. In some examples, a non-porous substrate can permit very little water absorption, at or below 0.1 vol %. In yet another example, a non-porous substrate can allow for gas permeability. In another example, however, a non-porous substrate can be substantially devoid of pores.

In some examples of the printing kit, the non-porous polymeric substrate is treated, or exposed to a surface treatment that renders the substrate more susceptible to ink adhesion. Examples of treated non-porous polymeric substrates include treated biaxially oriented polypropylene or other polyolefin, treated low density polyethylene (density less than 0.93 g/cm³), and treated high density polyethylene (density from 0.93 g/cm³ to 0.97 g/cm³).

In some examples of the printing kit, the non-porous polymeric substrate is untreated, which as noted herein, refers to both a lack of any chemical treatment, etching, coating, etc., as well as a lack of any specific mechanical treatment to modify the surface thereof, such as patterning, roughening, etc., in order to make the non-porous polymeric substrate more receptive to the inkjet inks. Furthermore, when referring to untreated substrates, this can also include non-porous polymeric substrates that can lack functional groups at a print surface that can aid in adhesion of ink to the substrate. In some examples, the untreated materials can be unmodified chemically and/or mechanically at the surface of the substrate as well as unmodified along the polymer chain of the material.

An example of an uncoated or untreated polymeric substrate may include a polyolefin, such as a polyethylene or a polypropylene. In another example, the non-porous polymeric substrate can be a biaxially oriented polyolefin, such as a biaxially oriented polypropylene or other polyolefin. In an example, the non-porous polymeric substrate is untreated biaxially oriented polypropylene. As used herein, a “biaxially-oriented” substrate refers to a substrate that has a stretched crystal or structural orientation in at least two directions or axes. This process can generate non-porous polymeric films that can have a higher tensile strength (per given thickness), greater stiffness, enhanced fluid barrier, etc. Biaxially-oriented substrates can have less permeability and can thereby limit diffusion compared to other types of substrates. Because these substrates tend to have enhanced fluid barrier properties, printing on biaxially-oriented substrates can be particularly challenging in some examples. The example non-aqueous inkjet inks disclosed herein have been found to be particularly suitable for biaxially-oriented substrates.

Some other examples of untreated non-porous polymeric substrates include polyvinyl chloride, low density polyethylene (density less than 0.93 g/cm³), high density polyethylene (density from 0.93 g/cm³ to 0.97 g/cm³), polyethylene terephthalate, polystyrene, polylactic acid, polytetrafluoroethylene (e.g., TEFLON® from the Chemours Company), or blends thereof, or blends of any of these with a polyolefin.

Non-porous substrates can be continuous non-fibrous structures.

In some examples, the non-porous polymeric substrate can also have low surface energy. In an example, the non-porous polymeric substrate is untreated and has a surface energy from about 18 mN/m to about 35 mN/m. In yet other examples, the substrate can have a surface energy ranging from about 20 mN/m to about 30 mN/m or from about 25 mN/m to about 35 mN/m. When untreated, in particular, the lack of functional groups along the polymer, the lack of surface modification of the substrate, and the low surface energy of the print surface can make this type of substrate difficult to print upon, as most ink compositions do not adhere well thereon. However, as shown in the Example section, the black non-aqueous inkjet inks disclosed herein have been found to be particularly suitable for these types of non-porous polymeric substrates.

“Surface energy” can be evaluated and quantified using contact angle measurement (goniometry) of a liquid applied to the surface of the polymer. The device used for taking the static contact angle measurement can be an FTA200HP or an FTA200, from First Ten Angstroms, Inc. For example, Young's equation (γ=γₛᵢ+γₗᵥ cos θ; where θ is the contact angle, γ is the solid surface free energy, γₛᵢ is the solid/liquid interfacial free energy, and γₗᵥ is the liquid surface free energy) can be used to calculate the surface energy from measured contact angle using a dyne fluid, e.g., water. However, in some instances where water is not a good dyne fluid for a particular test, other fluids, such as methylene iodide, ethylene glycol, formamide, etc., can be used to probe the surface generally or to probe different types of surface energy components while avoiding fluids that may dissolve or absorb into the surface. With polymer or non-porous substrates of the present disclosure, the dyne fluid selection generally provides very similar results that may be averaged to the extent there is some degree of different data. In addition to these considerations, dyne fluids can be selected which have known surface tension properties in a controlled atmosphere. In other words, by using dyne fluid(s) (liquid) and atmosphere (gas) with known free energies, and by measuring the contact angle (acute angle between the flat surface and the relative angle at the base of liquid where it contacts the flat surface) of the liquid bead on the polymer surface, these three pieces of data can be used with Young's equation to determine the surface energy of the polymer surface.

Printing Method

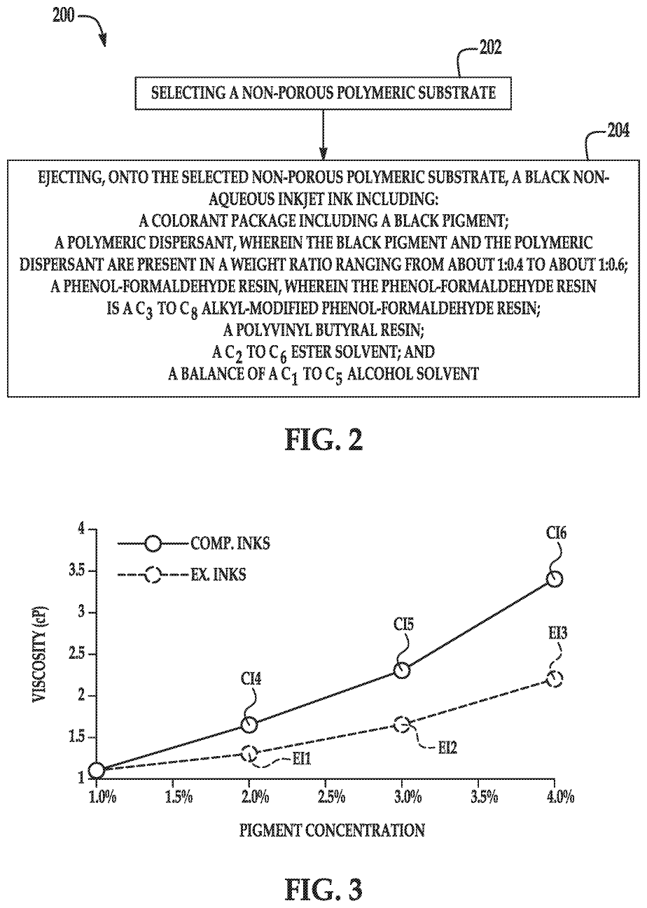

An example of the printing method 200 is shown in FIG. 2. The printing method 200 includes selecting a non-porous polymeric substrate (as shown at reference numeral 202); and then ejecting, onto the selected non-porous polymeric substrate, a black non-aqueous inkjet ink including a colorant package including a black pigment; a polymeric dispersant, wherein the black pigment and the polymeric dispersant are present in a weight ratio ranging from about 1:0.4 to about 1:0.6; a phenol-formaldehyde resin, wherein the phenol-formaldehyde resin is a C₃ to C₈ alkyl-modified phenol-formaldehyde resin; a polyvinyl butyral resin; a C₂ to C₆ ester solvent; and a balance of a C₁ to C₅ alcohol solvent. As described herein, the jetting ink may also include the cyan colorant.

The selected non-porous polymeric substrate may be any of the examples set forth herein.

Any example of the black non-aqueous inkjet ink disclosed herein may be jetted onto the selecting non-porous polymeric substrate using a thermal inkjet printer or a piezoelectric inkjet printer. As such, ejecting may involve dispensing the respective non-aqueous inkjet ink from a thermal inkjet printer or a piezoelectric inkjet printer. With thermal inkjet printing, momentary temperatures at fluidic surfaces at the thermal inkjet resistor can get to about 500° C. or more in some instances. It has been found that inks including the resin combination disclosed herein are not deleteriously affected at these temperatures, and thus do not negatively affect decap performance or result in an early onset of kogation. As such, the inkjet inks may be suitable for use in thermal inkjet printing. That stated, with piezo inkjet printheads, ink firing is not temperature dependent and this type of kogation may not occur; therefore, the example inks can also work well with piezo-actuated inkjet printheads.

To further illustrate the present disclosure, examples are given herein. It is to be understood that these examples are provided for illustrative purposes and are not to be construed as limiting the scope of the present disclosure.

### EXAMPLES

### Example 1

An example black pigment dispersion and a comparative example black pigment dispersion used in this example. The compositions of these dispersions are shown in Table 1.

TABLE 1

| | Example Black | Comp. Example |
|---|---|---|
| | Dispersion | Black Dispersion |
| Ingredient | (wt % active) | (wt % active) |
| Carbon Black Pigment | 10 | 10 |
| Polyvinyl Butyral Dispersant | 6.0 | 8.0 |
| Ethanol denatured with | Bal. | Bal. |
| tert-butanol and denatonium | | |
| benzoate | | |

Three example black inks (1, 2, 3) and three comparative example black inks (4, 5, 6) were using, respectively, the example black dispersion or the comparative example black dispersion. The dispersions were diluted to a desired pigment concentration of 2 wt %, 3 wt %, or 4 wt % with a solvent package. Additional resins were not included in either the example or comparative example inks. The compositions of these inks are shown in Table 2.

TABLE 2

| | | Example Inks | | | Comp. Example Inks | | |
|---|---|---|---|---|---|---|---|
| | | (wt % active) | | | (wt % active) | | |
| Ingredient | Specific component | 1 | 2 | 3 | 4 | 5 | 6 |
| Example carbon | Carbon Black Pigment | 2.0 | 3.0 | 4.0 | — | — | — |
| black dispersion | Polyvinyl Butyral | 1.2 | 1.8 | 2.4 | — | — | — |
| | Dispersant | | | | | | |
| Comp. Example | Carbon Black Pigment | — | — | — | 2.0 | 3.0 | 4.0 |
| carbon black | Polyvinyl Butyral | — | — | — | 1.6 | 2.4 | 3.2 |
| dispersion | Dispersant | | | | | | |
| Ratio of Pigment:Polymeric Dispersant | | 1:0.6 | 1:0.6 | 1:0.6 | 1:0.8 | 1:0.8 | 1:0.8 |
| Solvent Package | FLUOROLINK ® A10P | 0.3 | 0.3 | 0.3 | 0.3 | 0.3 | 0.3 |
| | Ethyl acetate | 5 | 5 | 5 | 5 | 5 | 5 |
| | Ethanol denatured with | Bal. | Bal. | Bal. | Bal. | Bal. | Bal. |
| | tert-butanol and | | | | | | |
| | denatonium benzoate | | | | | | |

The viscosity of example inks 1-3 (EI1, EI2, EI3) and comparative example inks 4-6 (CI4, CI5, CI6) was measured (at ambient temperature (25° C.) and pressure (1 atm)) using a Brookfield viscometer. The results are shown in FIG. 3. The viscosity of the example inks increased as the pigment concentration increased, and the viscosity of the comparative example inks increased as the pigment concentration increased. While the reduction in the dispersant concentration was expected to reduce the viscosity of the examples inks relative to the comparative example inks, the non-linearity of the viscosity reduction from one pigment concentration to another was quite unexpected. The reduction in viscosity between comp. ink 4 (CI4) and example ink 1 (EI1) was 0.35 cp, while the reduction in viscosity between comp. ink 5 (CI5) and example ink 2 (EI2) was about 0.65 cp (almost 2 times the reduction between comp. ink 4 and example ink 1) and the reduction in viscosity between comp. ink 6 (CI6) and example ink 3 (EI3) was about 1.2 cp (over 3 times the reduction between comp. ink 4 and example ink 1). The unexpectedly large viscosity reduction for example inks 2 and 3 made the jettability of these higher pigment concentration inks more reliable.

The example and comparative example inks were also tested for black optical density (KOD). The KOD was measured using a handheld spectrophotometer from Xrite. It was found that the optical density for example ink 1 and comp. ink 4 was good (e.g., about 1), and that the optical density for example ink 2 and comp. ink 5 was even better (about 1.6), and that the optical density for example ink 3 and comp. ink 6 was even better (about 1.75).

Two additional inks were also prepared similarly to the example and comparative example inks, except that the respective dispersions were diluted to a pigment concentration of 1 wt % with the solvent package. While the viscosity was very low for both inks (close to 1 cp), the KOD was very poor. The minimum pigment concentration for the example inks is thus about 2.0 wt %.

### Example 2

Two additional example inks (7 and 8) were prepared. These inks included the resin package disclosed herein. The compositions of these inks are shown in Table 3.

TABLE 3

Example Inks
(wt % active)

| Ingredient | Specific component | 7 | 8 |
|---|---|---|---|
| Example carbon | Carbon Black Pigment | 2.0 | 3.0 |
| black dispersion | Polyvinyl Butyral | 1.2 | 1.8 |
| | Dispersant | | |
| Resin Package | Polyvinyl butyral | 0.5 | 0.5 |
| | REACTOL ™ 1111E | 2 | 2 |
| Solvent Package | FLUOROLINK ® A10P | 0.3 | 0.3 |
| | Ethyl acetate | 5 | 5 |
| | Ethanol denatured with | Bal. | Bal. |
| | tert-butanol and | | |
| | denatonium benzoate | | |

The viscosity (measured at ambient temperature (25° C.) and pressure (1 atm) using a Brookfield viscometer) of examples inks 7 and 8 were 1.4 and 1.7, respectively. These viscosities are still relatively low with the added resin package.

Example inks 7 and 8 were each thermally inkjet printed on untreated low density polyethylene (UT-LDPE), treated low density polyethylene (T-LDPE) and on polyethylene terephthalate (PET). All prints included a single row of blocks, a QR code, several barcodes, and several lines.

The prints were tested for dry time, durability, and/or black optical density.

For the rub test, a certain amount of time was allowed to pass after a respective row was printed, and then a Sutherland rub tester was rubbed across the print from left to right across the row. Several rub tests were performed, including at 30 seconds dry time, 20 seconds dry time, 10 seconds dry time, 7 seconds dry time, 5 seconds dry time, and 3 seconds dry time. While the results are not reproduced herein, both examples inks 7 and 8 printed on UT-LDPE, T-LDPE, and PET exhibited no smearing as a result of the rub test, whether it was performed at 5 seconds, 3 seconds, or less, of dry time. As such, the reduction in viscosity did not deleteriously affect the dry time.

For the durability test, the prints were exposed to a rub test to determine the percent fade, which is indicative of print durability. The percent fade was calculated using the optical density difference of portions of the prints exposed to the rub test and not exposed to the rub test. For the rub test, a rub-tester, TMI® (Testing Machines Inc., New York) model #10-1801-0001, was used, which was fitted with an eraser having one drop squalene oil applied at the tip. The various prints were rubbed 30 times in three spots at a pressure of 30 psi. The prints were then scanned using an EPSON® V5000 Office Scanner (Seiko Epson Corp., Japan), and the optical density at the rubbed and not rubbed locations was determine with the QEA IAS Lab version 3 software. The percent fade (indicative of durability and adhesion) for the prints on each media type was calculated by dividing the optical density difference of rubbed and not rubbed areas by the optical density of the areas that are not rubbed. A percent fade of 30% or less is desirable, indicating suitable durability and adhesion of the print. While the results are not reproduced herein, both examples inks 7 and 8 printed on UT-LDPE, T-LDPE, and PET exhibited a percent fade of 30% or less. As such, the reduction in dispersant did not deleteriously affect the durability.

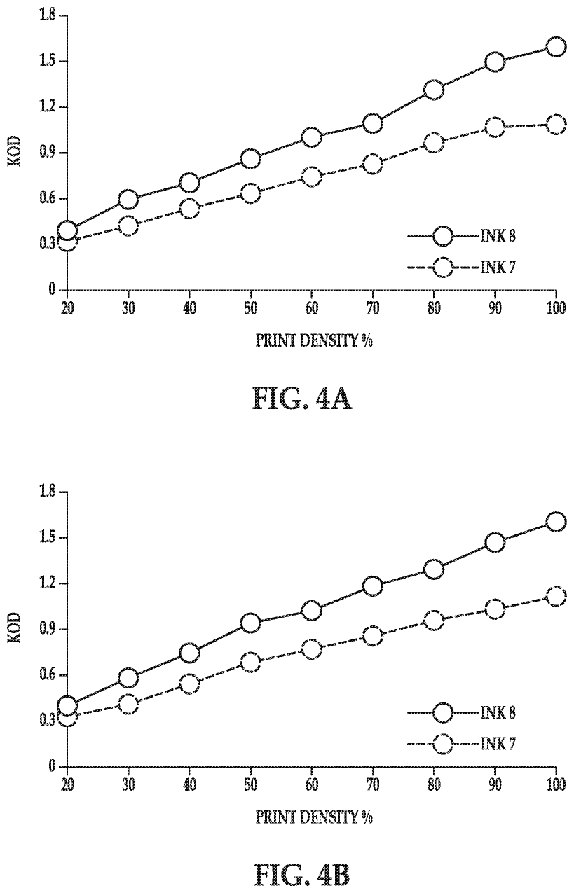

For the KOD test, examples inks 7 and 8 were printed at different print densities ranging from 20% to 100%, and the black optical density of each print was measured. The KOD was measured using a handheld spectrophotometer from Xrite. The KOD results for inks 7 and 8 on UT-LDPE are shown in FIG. 4A and the KOD results for inks 7 and 8 on PET are shown in FIG. 4B. The KOD for ink 7 (2 wt % pigment) on both types was media was greater than 0.8 at 70% print density, and was increased as the print density increased. The KOD for ink 8 (3 wt % pigment) on both types was media was greater than 1 at 70% print density, and was increased as the print density increased. The results for inks 7 and 8 indicate that the higher pigment concentration (3 wt %) results in an average of about 27% improvement in color compared to the lower pigment concentration (2 wt %).

### Example 3

Example ink 8 (from Example 2) was used in this example. Another comparative ink (comp. ink 9) was prepared in a similar manner as Example 1, except that the resin package was included. The compositions of these inks are shown in Table 4.

TABLE 4

| | | | Comp. |
|---|---|---|---|
| | | Example Ink 8 | Example Ink 9 |
| Ingredient | Specific component | (wt % active) | (wt % active) |
| Example carbon | Carbon Black Pigment | 3.0 | — |
| black dispersion | Polyvinyl Butyral | 1.8 | — |
| | Dispersant | | |
| Comp. Example | Carbon Black Pigment | — | 3.0 |
| carbon black | Polyvinyl Butyral | — | 2.4 |
| dispersion | Dispersant | | |
| Resin Package | Polyvinyl butyral | 0.5 | 0.5 |
| | REACTOL ™ 1111E | 2 | 2 |
| Solvent Package | FLUOROLINK ® A10P | 0.3 | 0.3 |
| | Ethyl acetate | 5 | 5 |
| | Ethanol denatured with | Bal. | Bal. |
| | tert-butanol and | | |
| | denatonium benzoate | | |

Example ink 8 and comp. example ink 9 were each thermally inkjet printed on untreated low density polyethylene (UT LDPE). All prints included several rows of blocks, several barcodes, several lines, and text.

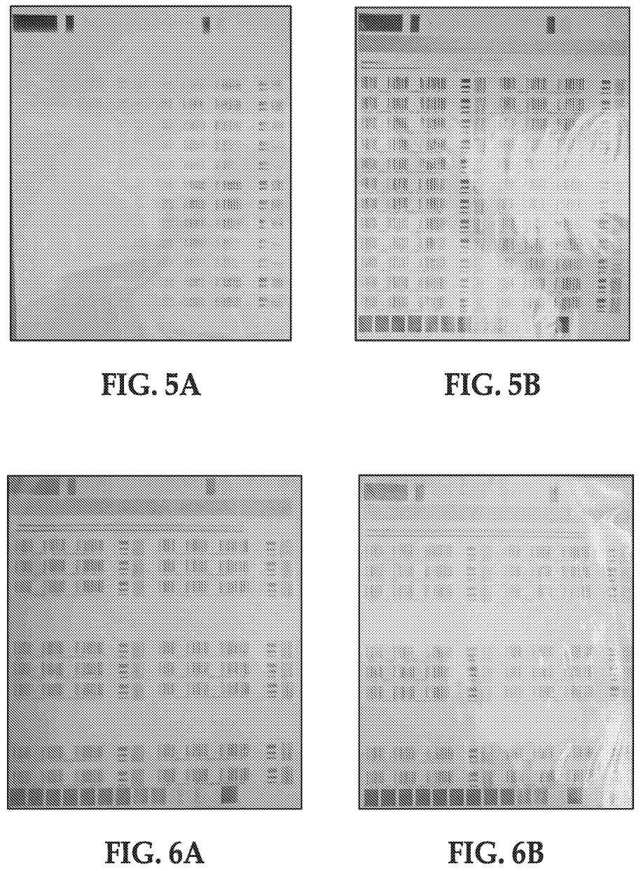

A photograph of each print was taken. FIG. 5A is a reproduction of the photograph of comp. example ink 9 on UT LDPE, and FIG. 5B is a reproduction of the photograph of example ink 8 on UT LDPE. A glare from the polymer substrate is visible in both images (left side of FIG. 5A and right side of FIG. 5B). However, it is clear that comp. example ink 9 (with a higher ratio of pigment:polymeric dispersant) suffered from printability issues, as some of the lines, barcodes, and text are barely visible. In contrast, example ink 8 reliably printed. The print quality of example ink 8 was overall better than the print quality of comp. example ink 9.

### Example 4

Two additional inks (example inks 10 and 11) were prepared for this example. The compositions of these inks are shown in Table 5.

TABLE 5

| | | Example Ink 10 | Example Ink 11 |
|---|---|---|---|
| Ingredient | Specific component | (wt % active) | (wt % active) |
| Example carbon | Carbon Black Pigment | 1.0 | 1.0 |
| black dispersion | Polyvinyl Butyral | 0.6 | 0.6 |
| | Dispersant | | |
| Cyan Colorant | Sanvinyl Blue RS | 0.6 | 0.6 |
| Resin Package | Polyvinyl butyral | 0.5 | 0.5 |
| | REACTOL ™ 1111E | 2 | 2 |
| Solvent Package | FLUOROLINK ® A10P | 0.3 | 0.3 |
| | Ethyl acetate | 5 | 5 |
| | Ethanol denatured with | Bal. | Bal. |
| | tert-butanol and | | |
| | denatonium benzoate | | |

Example inks 10 and 11 were each thermally inkjet printed on low density polyethylene (LDPE). All prints included several rows of blocks, several barcodes, several lines, and text.

A photograph of each print was taken. FIG. 6A is a reproduction of the photograph of example ink 10 (without cyan dye) on LDPE, and FIG. 6B is a reproduction of the photograph of example ink 11 on LDPE. A glare from the polymer substrate is visible in FIG. 6B. However, it is clear that example ink 10 (without cyan dye) had a more sepia tone (FIG. 6A), while example ink 11 (with cyan dye) has a more neutral black tone (FIG. 6B).

As such, in some examples of the ink disclosed herein, it may be desirable to include the cyan colorant.

It is noted that while 1 wt % pigment is not desirable for achieving good optical density, this concentration was used in this example so that the effect of the cyan dye could clearly be seen. The optical density is likely to be significantly increased for both example inks 10 and 11 when the pigment concentration is increased, as evidenced by the data set forth in FIG. 4A and FIG. 4B in Example 2.

It is to be understood that the ranges provided herein include the stated range and any value or sub-range within the stated range, as if such values or sub-ranges were explicitly recited. For example, from about 0.5 wt % to about 2 wt % should be interpreted to include not only the explicitly recited limits of from about 0.5 wt % to about 2 wt %, but also to include individual values, such as about 0.85 wt %, about 1.55 wt %, about 1.9 wt %, etc., and sub-ranges, such as from about 0.8 wt % to about 1.9 wt %, from about 0.6 wt % to about 1.6 wt %, from about 0.75 wt % to about 1.75 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A black non-aqueous inkjet ink, comprising:
a colorant package including a black pigment;
a polymeric dispersant, wherein the black pigment and the polymeric dispersant are present in a weight ratio ranging from about 1:0.4 to about 1:0.6;
a phenol-formaldehyde resin, wherein the phenol-formaldehyde resin is a C₃ to C₈ alkyl-modified phenol-formaldehyde resin;
a C₂ to C₆ ester solvent; and
a balance of a C₁ to C₅ alcohol solvent.

2. The black non-aqueous inkjet ink as defined in claim 1 wherein:
the black pigment is present in the black non-aqueous inkjet ink in an amount up to 4 wt %, based on a total weight of the black non-aqueous inkjet ink; and
the polymeric dispersant is present in the black non-aqueous inkjet ink in an amount up to about 2.4 wt % of the total weight of the black non-aqueous inkjet ink.

3. The black non-aqueous inkjet ink as defined in claim 1 wherein the colorant package consists of the black pigment and a cyan colorant, and wherein the cyan colorant is a cyan dye or a cyan pigment.

4. The black non-aqueous inkjet ink as defined in claim 3 wherein the cyan colorant is present in an amount ranging from about 0.5 wt % to about 2 wt %, based on a total weight of the black non-aqueous inkjet ink.

5. The black non-aqueous inkjet ink as defined in claim 1, further comprising a perfluoropolyether surfactant, a hydroxythioether surfactant, or a combination thereof.

6. The black non-aqueous inkjet ink as defined in claim 5 wherein the perfluoropolyether surfactant, the hydroxythioether surfactant, or the combination thereof is present in an amount ranging from about 0.25 wt % to about 0.35 wt % of a total weight of the black non-aqueous inkjet ink.

7. The black non-aqueous inkjet ink as defined in claim 1 wherein the C₂ to C₆ ester solvent is present in an amount ranging from about 2 wt % to about 10 wt %, based on a total weight of the black non-aqueous inkjet ink.

8. The black non-aqueous inkjet ink as defined in claim 1, further comprising a polyvinyl butyral resin.

9. The black non-aqueous inkjet ink as defined in claim 8 wherein a ratio of the polyvinyl butyral resin to the phenol-formaldehyde resin ranges from 1:10 to 1:1.5, and wherein a combined total of the polyvinyl butyral resin and the phenol-formaldehyde resin in the non-aqueous inkjet ink ranges from about 2 wt % active to about 3 wt % active, based on a total weight of the black non-aqueous inkjet ink.

10. The black non-aqueous inkjet ink as defined in claim 8 wherein:
the polyvinyl butyral resin is present in an amount ranging from about 0.1 wt % up to 1 wt %, based on a total weight of the black non-aqueous inkjet ink; and
the phenol-formaldehyde resin is present in an amount ranging from about 0.5 wt % up to 2.5 wt %, based on the total weight of the black non-aqueous inkjet ink.

11. A black non-aqueous inkjet ink, consisting of:
a colorant package consisting of a non-self-dispersed black pigment and a cyan colorant;
a polymeric dispersant, wherein the non-self-dispersed black pigment and the polymeric dispersant are present in a weight ratio ranging from about 1:0.4 to about 1:0.6;
from about 0.25 wt % to about 0.35 wt % of a perfluoropolyether surfactant, a hydroxythioether surfactant, or a combination thereof, based on a total weight of the black non-aqueous inkjet ink;
from about 2 wt % to about 10 wt % of a C₂ to C₆ ester solvent, based on the total weight of the black non-aqueous inkjet ink;
water in an amount less than 1 wt %, based on the total weight of the black non-aqueous inkjet ink;
a balance of a C₁ to C₅ alcohol solvent; and
an optional resin package consisting of a C₃ to C₈ alkyl-modified phenol-formaldehyde resin and a polyvinyl butyral resin.

12. The black non-aqueous inkjet ink as defined in claim 11 wherein the cyan colorant is present in an amount ranging from about 0.5 wt % to about 2 wt %, based on the total weight of the black non-aqueous inkjet ink.

13. A method, comprising:
providing a baseline solvent package consisting of:
a perfluoropolyether surfactant, a hydroxythioether surfactant, or a combination thereof;
a C₂ to C₆ ester solvent; and
a C₁ to C₅ alcohol solvent;
optionally adding a cyan colorant to the baseline solvent package; and
adding a black pigment dispersion to the baseline solvent package to generate a black non-aqueous inkjet ink containing up to 4 wt % of a non-self-dispersed black pigment, up to 2.4 wt % of a polymeric dispersant, and up to 1 wt % of water, each based on a total weight of the black non-aqueous inkjet ink, wherein the black pigment dispersion includes:
the non-self-dispersed black pigment;
the polymeric dispersant, wherein the non-self-dispersed black pigment and the polymeric dispersant are present in a weight ratio ranging from about 1:0.4 to about 1:0.6; and
a balance of a second C₁ to C₅ alcohol solvent.

14. The method as defined in claim 13 wherein the cyan colorant is added and is present in the black non-aqueous inkjet ink in an amount ranging from about 0.5 wt % to about 2 wt %, based on the total weight of the black non-aqueous inkjet ink.

15. The method as defined in claim 13, further comprising adding a resin package to the baseline solvent package, the resin package consisting of a C₃ to C₈ alkyl-modified phenol-formaldehyde resin and a polyvinyl butyral resin.
